(19) United States
(12) Patent Application Publication
(10) Pub. No.: US 2013/0061621 A1
(43) Pub. Date: Mar. 14, 2013

(54) AUXILIARY POWER UNIT

(71) Applicant: Terry R. Nielsen, Austin, TX (US)

(72) Inventor: Terry R. Nielsen, Austin, TX (US)

(73) Assignee: Hodyon, Inc., Cedar Park, TX (US)

(21) Appl. No.: 13/606,575

(22) Filed: Sep. 7, 2012

Related U.S. Application Data
(60) Provisional application No. 61/534,216, filed on Sep. 13, 2011.

(51) Int. Cl. B60H 1/22; B60R 16/00; F25B 27/00; B60H 1/32

(52) U.S. Cl. 62/236; 62/244; 165/202

(57) ABSTRACT

Certain embodiments are directed to components, subassemblies, systems, and/or methods for auxiliary power units (APU). In one embodiment, the APU is provided with a control system having an automatic start process. The automatic start process enables operation of the APU within a preset range of battery voltage, time, temperature and other parameters. In yet other embodiments, the APU is provided with a control system having a data verification process. The data verification process can be configured to set the operating mode of the APU. In one embodiment, the operating mode of the APU is a “purchase” mode. In other embodiments, the operating mode of the APU is a “lease” mode.

### CROSS REFERENCE TO RELATED APPLICATIONS

This application claims the benefit of U.S. Provisional Patent Application No. 61/534,216, filed on Sep. 13, 2011, which is hereby incorporated by reference in its entirety.

### BACKGROUND

1. Field

This disclosure relates generally to devices and methods for providing auxiliary air conditioning, heating, and power to a vehicle.

2. Description of the Related Art

Auxiliary power units are often used in cross-country trucks that are equipped with a sleeper compartment located behind a truck cab so that the driver has a convenient place to sleep while in route. An Auxiliary Power Unit (APU) allows the driver to use the truck's amenities like heat, air conditioning, microwave, television, etc. without running the engine, which reduces emissions. See, for example, U.S. Pat. No. 5,333,678 to Mellum, which is hereby incorporated by reference in its entirety. APUs are also used extensively in refrigerated trailers for maintaining cargo temperatures during transport and delivery.

APUs have become significantly more important in the heavy duty trucking industry because the Environmental Protection Agency (EPA) and the California Air Resource Board (CARB) have been developing and passing regulations that impact idling in an attempt to reduce emissions and pollution. The passage of these different regulations has impacted the trucking industry. In particular, it has affected the heavy duty (Class 8) sleeper tractor drivers who typically idle their vehicle for many hours each day. It is estimated that drivers are on the road five days per week. Federal law states that drivers are only allowed to be on the road a maximum of 14 hours a day with 10 hours down time required. Therefore, the sleeper cab industry has a large potential for APUs to reduce idling during the required downtime. Over half of the states in the U.S. have anti-idling regulations in place, and this number is projected to increase as more states adopt CARB regulations. Beyond the numerous federal and state regulations against idling, the industry is also facing idling regulations at the local and municipal levels as well. While their regulations vary by location, they all prohibit trucks from idling over three to five minutes. Some industry experts believe that the environmental agencies are gaining momentum in their initiative to put more pressure on the Federal government as well as on states to make the idling regulations even more stringent in the coming years. If the environmental agencies succeed, some form of anti-idling technology (not just APUs) will become a necessity for truck drivers expanding beyond Class 8 sleeper tractors.

The rise and fall of diesel fuel prices continues to play a role in the adoption of idle reduction technology as users (particularly fleets) seek to lower their fuel consumption especially when diesel prices are high. When diesel fuel prices reached an all time high in 2008, demand for idle reduction technology increased because of the roughly 8% fuel savings they offer. In the long run, most industry experts expect diesel fuel prices to rise, which will again spark interest in APUs as they help to reduce fuel consumption as well as reducing wear and tear on the engine.

Most commercially available APU systems are provided with an auxiliary engine and an auxiliary generator that provide basic electrical support for a truck. The truck typically has a cab and a sleeper to which the APU provides auxiliary air conditioning and heating. The truck, in some cases, has a cab evaporator, a sleeper evaporator, a compressor, a condenser, and a plurality of refrigerant lines, a cab heater, a sleeper heater, and a plurality of coolant lines. Most APU's have a plurality of auxiliary coolant lines which are interconnected with the truck's coolant lines. The interconnection is accomplished in such a way that the APU can provide heat to the sleeper heater when the truck engine is running or when the truck is not running. See, for example, U.S. Pat. No. 5,333,678 to Cummins, which is hereby incorporated by reference in its entirety. However, managing the interior climate, and in particular the heat, with the APU when the truck is not running can be inefficient. Therefore, there is a need for and APU and control systems that provide efficient and sufficient heat for the truck cab and engine.

### SUMMARY

The systems and methods herein described have several features, no single one of which is solely responsible for its desirable attributes. Without limiting the scope as expressed by the claims that follow, its more prominent features will now be discussed briefly. After considering this discussion, and particularly after reading the section entitled “Detailed Description of Certain Embodiments” one will understand how the features of the system and methods provide several advantages over traditional systems and methods.

One aspect of the disclosure relates to a method of controlling an auxiliary power unit having an engine and a generator. In one embodiment, the method includes the step of receiving a signal indicative of a data verification code. The method has a step of determining an operating mode based at least in part on the data verification code. In some embodiments, the method includes setting the operating mode of the APU.

Another aspect of the disclosure is directed to an auxiliary power unit (APU) having an engine. The APU can be provided with a controller in communication with the engine. In one embodiment, the APU has a user-interface in electrical communication with the controller. The user-interface is adapted to receive a signal from a user. The signal is indicative of a data verification code.

Yet another aspect of the disclosure concerns a method of controlling an auxiliary power unit for a vehicle having the step of receiving a signal indicative of a temperature set point. The method has the step of comparing the signal to a range, the range set by a user, the range within a first value and a second value. In one embodiment, the method has the step of commanding an automatic start routine based on the result of comparing the signal.

### BRIEF DESCRIPTION OF THE FIGURES

FIG. 1 is a schematic illustration of one embodiment of an exemplary vehicle having an auxiliary power unit (APU).

FIG. 2 is a schematic illustration of one embodiment of an auxiliary power unit and control system.

FIG. 3 is a flow chart of an auto-start control process that can be used with the APU of FIG. 1 or 2.

FIG. 4 is a flow chart of a data verification control process that can be used with the APU of FIG. 1 or 2.

### DETAILED DESCRIPTION OF CERTAIN EMBODIMENTS

The preferred embodiments will be described now with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the disclosure. Furthermore, embodiments disclosed herein can include several novel features, no single one of which is solely responsible for its desirable attributes or which is essential to practicing the embodiments described.

As used here, the terms “operationally connected,” “operationally coupled,” “operationally linked,” “operably connected,” “operably coupled,” “operably linked,” and like terms, refer to a relationship (mechanical, linkage, coupling, etc.) between elements whereby operation of one element results in a corresponding, following, or simultaneous operation or actuation of a second element. It is noted that in using said terms to describe certain embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

One aspect of the disclosure relates to auxiliary power units wherein a prime mover drives various driven devices. Auxiliary power units disclosed here can be used in various trucking and transport vehicles including, but not limited to, refrigeration trucks, recreational vehicles, buses, locomotives, service vehicles, trash trucks, marine vehicles, Class 3 and Class 8 trucks, among others. The prime mover can be, for example, an electrical motor and/or a combustion engine. For purposes of description here, an accessory includes any machine or device that can be powered by a prime mover. For purposes of illustration and not limitation, said machine or device can be a power takeoff device (PTO), pump, compressor, generator, auxiliary electric motor, etc. Accessory devices configured to be driven by a prime mover may also include refrigeration systems, alternators, water pumps, power steering pumps, fuel pumps, oil pumps, air conditioning compressors, cooling fans, superchargers, turbochargers and any other device that is typically powered by a prime mover. Embodiments disclosed here can be used to control the power delivered to the accessories powered by a prime mover.

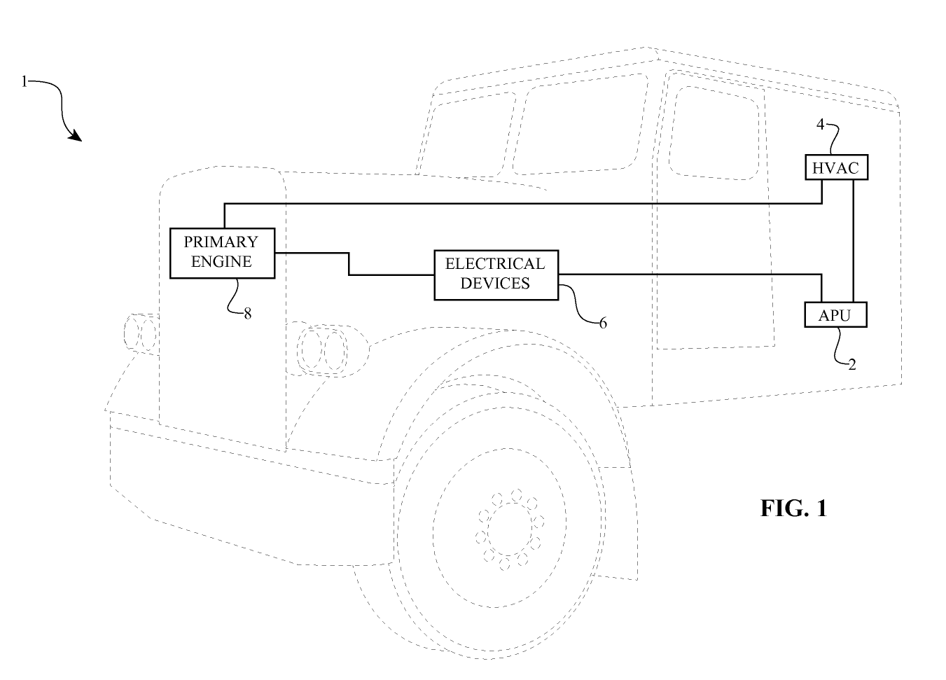

Referring now to FIG. 1, in one embodiment, an exemplary vehicle 1 can be equipped with an auxiliary power unit 2, a heating-ventilation-air conditioning (HVAC) system 4, and a plurality of electrical devices 6. In some embodiments, the electrical devices 6 can include an engine block heater, a plurality of electrical outlets, and a cab heater, for example. The HVAC system 4 and electrical devices 6 can be operably coupled to the APU 2 and a primary engine 8.

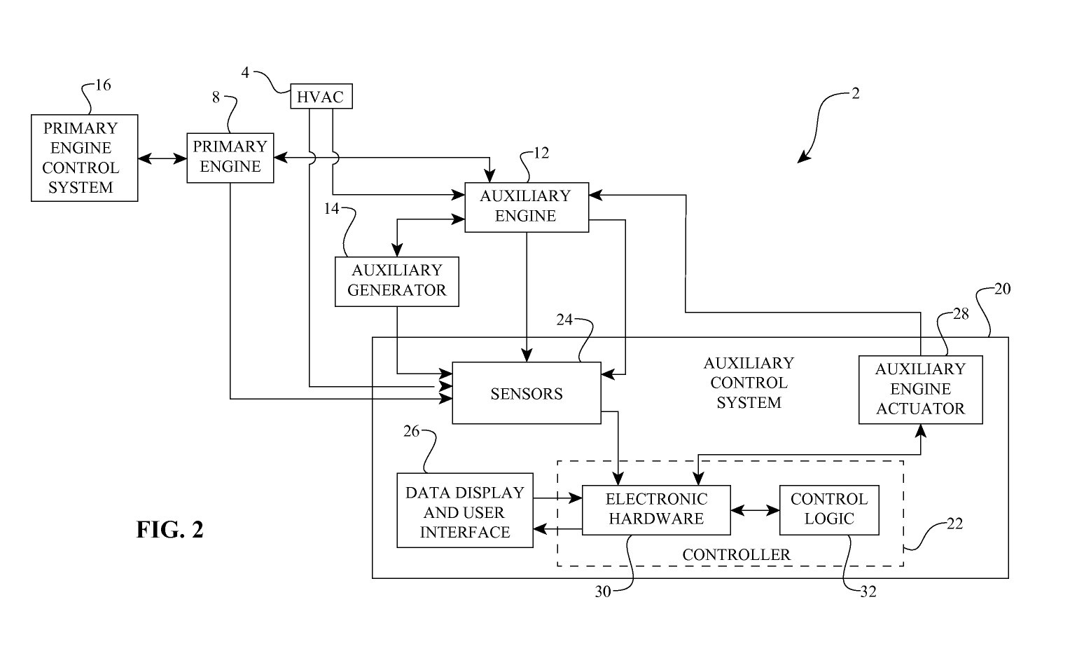

Turning now to FIG. 2, the APU 2 can include, among other things, an auxiliary engine 12 operably coupled to an auxiliary generator 14. In one embodiment, an auxiliary control system 20 can be used with, for example, the APU 2. For description purposes, the auxiliary engine 12 and the auxiliary generator 14, among other hardware, are depicted as blocks in FIG. 2. In some embodiments, the primary engine 8 is provided with an engine control system 16. In other embodiments, the engine control system 16 can be integrated into the auxiliary control system 20. In one embodiment, the auxiliary control system 20 includes a controller 22 in communication with sensors 24, a data display and user interface 26, and an auxiliary engine actuator 28. The auxiliary engine actuator 28 can be operably coupled to the auxiliary engine 12 to thereby facilitate a change in operating condition of the auxiliary engine 14. For example, the engine actuator 28 can be a linear actuator, a pneumatic actuator, or a servo actuator coupled to an accelerator, a throttle, or other control component of the primary engine 8. In one embodiment, the controller 22 includes electronic hardware 30 in communication with control logic 32. In some embodiments, the sensors 24 are adapted to sense conditions of the auxiliary engine 12, the auxiliary generator 14, the primary engine 8, the HVAC system 4, and/or the electrical devices 6. For example, the sensors 24 can sense engine speed, generator speed, generator voltage, generator current, engine temperature, cabin temperature, water temperature, and many other variables common to operating an engine, HVAC system, and/or generator. In some embodiments, the data display and user interface 26 can be accessible on the interior of a vehicle, for example. In other embodiments, the data display and user interface 26 can be remotely mounted or in wireless communication with the controller 22, for example. In yet other embodiments, the data display and user interface 26 can be adapted to receive wireless transmissions such as a text message containing information about the usage of the APU 2.

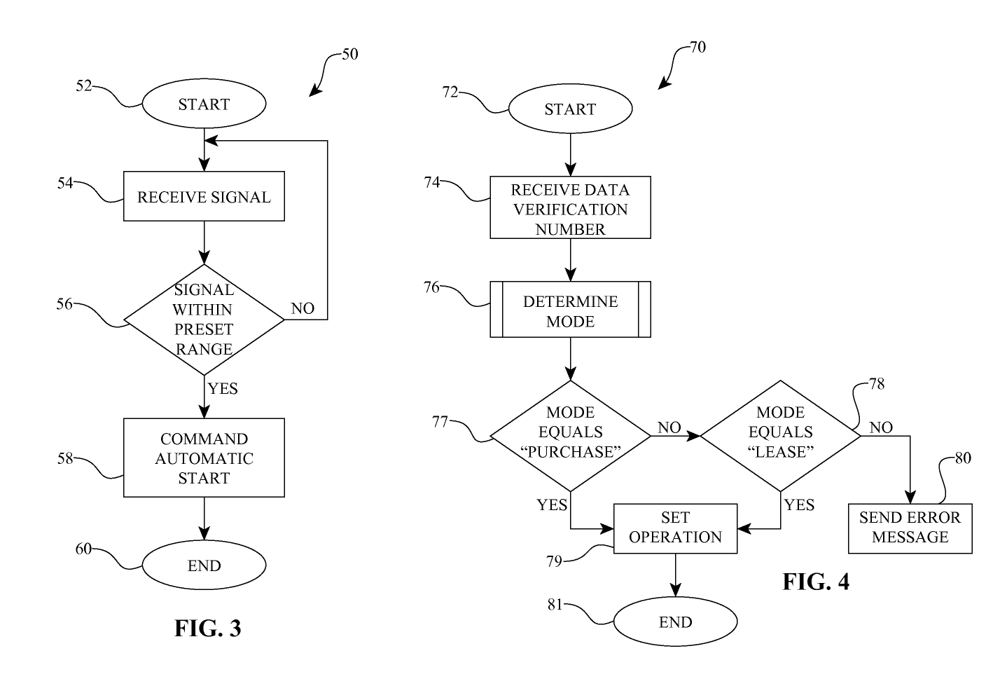

Turning to FIG. 3 now, in one embodiment, an automatic start control process 50 can be implemented in the control system 22, for example. In this embodiment, the control process 50 begins at a state 52 and proceeds to a state 54 where a signal is received. The signal received in state 54 can be indicative of a battery voltage of a truck having an APU. In some embodiments, the signal received in state 54 can be indicative of a coolant temperature of an APU. In other embodiments, the signal received in state 54 is indicative of a coolant temperature of a truck. In yet other embodiments, the signal received in state 54 is indicative of a desired temperature set by a user of an APU. The control process 50 moves to a state 56 where the signal is evaluated and compared to a preset range. If the signal is within the preset range, the control process 50 proceeds to a state 58 where a command is generated to start the engine 12, for example. If the signal is not within the preset range, the process 50 returns to state 54. The process 50 ends at an end state 60. In some embodiments, the state 56 can be configured to produce a positive result if the signal is outside of a preset range. For example, a user can configure an automatic start of the engine 12, for example, if the temperature is below a lower limit or above an upper limit.

Referring now to FIG. 4, a data verification process 70 can be implemented on controller 22, for example. The data verification process 70 begins at start state 72 and proceeds to state 74 where a data verification code, for example an encrypted character string or number, is received. An encrypted character string can be an alpha numeric message generated by common encryption methods. In one embodiment, a user inputs the number or alpha numeric code through the user interface 26, for example. In other embodiments, the encrypted message or signal, for example the number or the alpha numeric code, is received through a wireless communication with the controller 22. The process 70 proceeds to state 76 where an operating mode is determined based at least in part on the data verification code. In one embodiment, the data verification code can be indicative of a “purchase” mode or a “lease” mode. The process 70 moves to state 77 where the mode is evaluated. If the mode is equal to the “purchase” mode, the process 70 proceeds to state 79. If the mode is not equal to “purchase” mode, the process moves to state 78. The mode is evaluated at the state 78. If the mode is equal to the “lease” mode, then the process proceeds to the state 79. If the mode is not equal to “lease” mode, the process 70 moves to state 80 where an error message is sent. At state 79, the operating mode of the APU is set to “purchase” or “lease” or other predetermined mode. In one embodiment, the “purchase” mode is indicative of operating the APU for an unlimited time and the “lease” mode is indicative of operating the APU for a limited time. The selection of modes can be implemented as part of a sales program where the manufacturer of the APU provides flexible purchasing or leasing agreements with the APU users.

In one embodiment, the controller 22 can send or transmit signals to the user interface 26 or a remote user via a wireless signal. In some embodiments, the controller 22 sends trouble codes or error codes to report a problem during operation of the APU. For example, the controller 22 can send a signal to the user-interface 26 for maintenance on a specific component.

Those of skill will recognize that the various illustrative logical states, modules, circuits, and algorithm steps described in connection with the embodiments disclosed herein, including with reference to the control system 20, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor can read information from, and write information to, the storage medium. In the alternative, the storage medium may be integral to the processor. The processor and the storage medium may reside in an ASIC. For example, in one embodiment, the controller 22 comprises a processor (not shown).

It should be noted that the description above has provided dimensions for certain components or subassemblies. The mentioned dimensions, or ranges of dimensions, are provided in order to comply as best as possible with certain legal requirements, such as best mode. However, none of the mentioned dimensions are to be considered limiting on the disclosed embodiments.

The foregoing description details certain embodiments of the disclosure. It will be appreciated, however, that no matter how detailed the foregoing appears in text, the disclosure can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the disclosure with which that terminology is associated.

One or more embodiments described above can be claimed as follows, but this list is not exhaustive and the description contains other embodiments.

What is claimed is:

1. An auxiliary power unit (APU) comprising:
an engine;
a controller in communication with the engine;
a user-interface in electrical communication with the controller, the user-interface adapted to receive a signal from a user;
wherein the signal is indicative of a data verification code.

2. The APU of Clam 1, wherein the user-interface receives the signal by a wireless transmission.

3. The APU of claim 2, wherein the wireless transmission is in the form of a text message.

4. The APU of claim 1, wherein the data verification code is an encrypted message containing information regarding operating mode of the APU.

5. The APU of claim 4, wherein if the operating mode of the APU is a lease mode, the controller allows operation of the APU for a predetermined amount of time.

6. The APU of claim 4, wherein if the operating mode of the APU is a purchase mode, the controller allows operation of the APU for an indefinite amount of time.

7. The APU of claim 1, wherein the controller can send an encrypted signal to the user, the encrypted signal indicative of an error during operation of the APU.

8. The APU of Claim, 7, wherein the encrypted signal is indicative of a quantity of time of APU operation.

9. A method of controlling an auxiliary power unit for a vehicle, the method comprising the steps of:
receiving a signal indicative of a data verification code;
determining an operating mode based at least in part on the data verification code; and
setting the operating mode of the APU.

10. The method of Clam 9, wherein receiving a signal comprises the step of receiving the signal by a wireless transmission.

11. The method of claim 10, wherein receiving the wireless transmission comprises the step of receiving a text message.

12. The method of claim 9, wherein determining the data verification code comprises the step of receiving an encrypted message containing information regarding operating mode of the APU.

13. The method of claim 12, wherein setting the operating mode of the APU comprises the step of setting the APU to a lease mode, wherein the controller allows operation of the APU for a predetermined amount of time.

14. The method of claim 12, wherein setting the operating mode of the APU comprises the step of setting a purchase mode, wherein the controller allows operation of the APU for an indefinite amount of time.

15. A method of controlling an auxiliary power unit for a vehicle, the method comprising the steps of:
receiving a signal indicative of a temperature set point;
comparing the signal to a range, the range set by a user, the range within a first value and a second value;
commanding an automatic start routine based on the result of comparing the signal.

16. The method of claim 15, wherein comparing the signal to a range comprises sending a positive result based at least upon the temperature set point being above the first value.

17. The method of claim 15, wherein comparing the signal to a range comprises sending a negative result based at least upon the temperature set point being above the first value.

18. The method of claim 15, wherein comparing the signal to a range comprises sending a positive result based at least upon the temperature set point being below the second value.

19. The method of claim 15, wherein comparing the signal to a range comprises sending a negative result based at least upon the temperature set point being below the second value.

20. The method of claim 15, further comprising the step of measuring the actual temperature of a truck cabin.
